(19) United States
(12) Patent Application Publication
(10) Pub. No.: US 2025/0301939 A1
(43) Pub. Date: Oct. 2, 2025

(54) FURROW OPENER TRIP SHOCK ABSORBER

(71) Applicant: SEEDMASTER MANUFACTURING LTD., EMERALD PARK (CA)

(72) Inventor: Norbert BEAUJOT, Emerald Park (CA)

(21) Appl. No.: 19/092,398

(22) Filed: Mar. 27, 2025

(30) Foreign Application Priority Data
Mar. 28, 2024 (CA) 3233694

(51) Int. Cl. A01C 5/06; A01B 35/06

(52) U.S. Cl. CPC A01C 5/062; A01B 35/06; A01C 5/068

(57) ABSTRACT

A seeding apparatus comprises an implement frame and a trailing arm apparatus pivotally attached at a front portion thereof to the implement frame and extending rearward and downward to a packer wheel. The trailing arm apparatus is biased downward and the packer wheel moves upward and downward against a downward bias force. A shank is pivotally attached to the trailing arm apparatus and a furrow opener attached to a lower end of the shank. The shank is operative to pivot forward and rearward about the shank pivot axis in a trip range between a forward shank operating position and a rearward stop member. A shank bias element is attached to the shank operates to exert a shank bias force on the shank toward the shank operating position. A shock absorber is operative to compress when the shank pivots to a rear end of the trip range.

This invention relates to agricultural implements and more specifically to a seeding apparatus with a furrow opener shank pivotally attached to a trailing arm.

### BACKGROUND OF THE INVENTION

Seeding implements commonly comprise a trailing arm arrangement spread across the width of the implement frame. U.S. Pat. No. 10,681,858 to Beaujot shows such an implement frame with a trailing arm pivotally attached at a front end thereof to the frame about a horizontal arm pivot axis, oriented substantially perpendicular to the operating travel direction of the implement frame and extending downward and rearward to a packer wheel rotatably mounted on the rear end thereof. An arm bias element, typically provided by a hydraulic cylinder, is attached between the frame and the trailing arm and exerts a downward arm bias force on the trailing arm about the arm pivot axis forcing the packer wheel against the ground and pushing a furrow opener, attached to a downward extending shank, into the ground at a depth dictated by the vertical distance between the furrow opener and the bottom of the packer wheel.

In one common arrangement the downward extending shank is pivotally connected to the trailing arm about a horizontal shank pivot axis, again oriented perpendicular to the travel direction. The arm bias element is attached to the shank and exerts the arm bias force on the trailing arm through the shank. The arm bias force moves the shank, and the attached furrow opener, to a shank operating position.

When an obstruction, such as a rock or the like, is encountered by the furrow opener, the furrow opener “trips”, rotating the shank against the arm bias force such that the furrow opener moves rearward and upward over the obstruction and then moves downward and forward once the obstruction is passed. The shank and furrow opener are able to trip by pivoting against the arm bias force from the shank operating position rearward to a trip limit position where the shank meets a rearward stop member. The trip force is determined by the arm bias force, typically the hydraulic pressure in the hydraulic cylinder, applied to keep the shank and furrow opener forward in shank operating position.

If the rock shape is such that the furrow opener is still encountering the rock at the trip limit position, the trailing arm apparatus and attached packer wheel are further raised against the arm bias force and the furrow opener and packer wheel pass over the larger obstruction.

### SUMMARY OF THE INVENTION

It is an object of the present invention to provide a seeding apparatus that overcomes problems in the prior art.

When the furrow opener first meets a smaller obstruction, it trips and is pushed back and moves in a trip range between the shank operating position and the trip limit position at a rearward stop member and there is some decrease in the downward force on the trailing arm and packer wheel. The furrow opener clears such smaller obstructions while moving back and forth in the trip range.

However, where the obstruction is quite large and the furrow opener is still encountering the rock at the trip limit position, the shank impacts the rearward stop member to raise the trailing arm and attached packer wheel against the arm bias force to allow the furrow opener and packer wheel to pass over the larger obstruction.

When the shank impacts the rearward stop member this impact results in a much higher impact force than the first impact which caused the furrow opener to trip because the impact against the rearward stop member raises the entire trailing arm and packer wheel. Especially at higher speeds, damage from this second impact can be significant breaking bolts or damaging the furrow opener, shank, or other parts of the system.

The present invention provides a shock absorber at the rearward stop member to release some of the energy of this second impact by slowing the shank before the end of the trip range when the trailing arm and packer wheel are raised.

The present invention provides a seeding apparatus comprising an implement frame mounted on wheels for travel over the ground in an operating travel direction. A trailing arm apparatus is pivotally attached at a front portion thereof to the implement frame and extends rearward and downward to a packer wheel rotatably mounted to a rear portion of the trailing arm and the trailing arm apparatus is biased downward such that the packer wheel moves upward and downward against the downward bias force with respect to the implement frame. A shank is pivotally attached at an upper portion of the shank to the trailing arm apparatus about a substantially horizontal shank pivot axis, and a furrow opener is attached to a lower end of the shank. The shank is operative to pivot forward and rearward about the shank pivot axis in a trip range between a forward shank operating position and a rearward stop member. A shank bias element is attached to the shank and is operative to exert a shank bias force on the shank toward the shank operating position. A shock absorber operative to compress when the shank pivots to a rear end of the trip range.

The apparatus of the present invention reduces damage to trailing arm type furrow openers by reducing the speed at which the limit pin contacts the end of the trip range, and thus reducing shock forces on the seeding apparatus.

### DESCRIPTION OF THE DRAWINGS

While the invention is claimed in the concluding portions hereof, preferred embodiments are provided in the accompanying detailed description which may be best understood in conjunction with the accompanying diagrams where like parts in each of the several diagrams are labeled with like numbers, and where:

FIG. 1 is a schematic side view of an embodiment of the present invention with the shank shown in a forward shank operating position;

FIG. 2 is a schematic side view of the embodiment of FIG. 1 with the shank shown in a trip limit position;

FIG. 3 is a schematic side view of the embodiment of FIG. 1 with the trailing arm raised such that the packer wheel is above the ground;

FIG. 4 schematically illustrates in more detail the shank in the shank operating position of FIG. 1;

FIG. 5 schematically illustrates in more detail the shank in the in a trip limit position of FIG. 2;

FIG. 6 schematically illustrates the limit pin contacting the shock absorber;

FIG. 7 schematically illustrates an alternate shock absorber;

FIG. 8 schematically illustrates an alternative seeding apparatus where the limit slot is mounted to the trailing arm and the limit pin is fixed to the shank;

FIG. 9 schematically illustrates a further alternate seeding apparatus where the shock absorber is provided by a compression spring;

FIG. 10 schematically illustrates a further alternate seeding apparatus of the present invention where the trailing arm apparatus includes a parallel arm assembly, and further includes one hydraulic cylinder to provide the shank bias force and a separate hydraulic cylinder to provide a downward bias force on the trailing arm apparatus;

FIG. 11 is a cut-away view if the embodiment of FIG. 10; showing the shank in the shank operating position;

FIG. 12 is a cut-away view if the embodiment of FIG. 10; showing the shank in the trip limit position;

FIG. 13 schematically illustrates a further alternate seeding apparatus 401 where the shank bias element is provided by a spring;

FIG. 14 schematically illustrates a further alternate seeding apparatus 501 where the trip range is defined by the limits of extension and retraction of the hydraulic cylinder;

FIG. 15 schematically illustrates the shock absorber of the seeding apparatus of FIG. 14.

### DETAILED DESCRIPTION OF THE ILLUSTRATED EMBODIMENTS

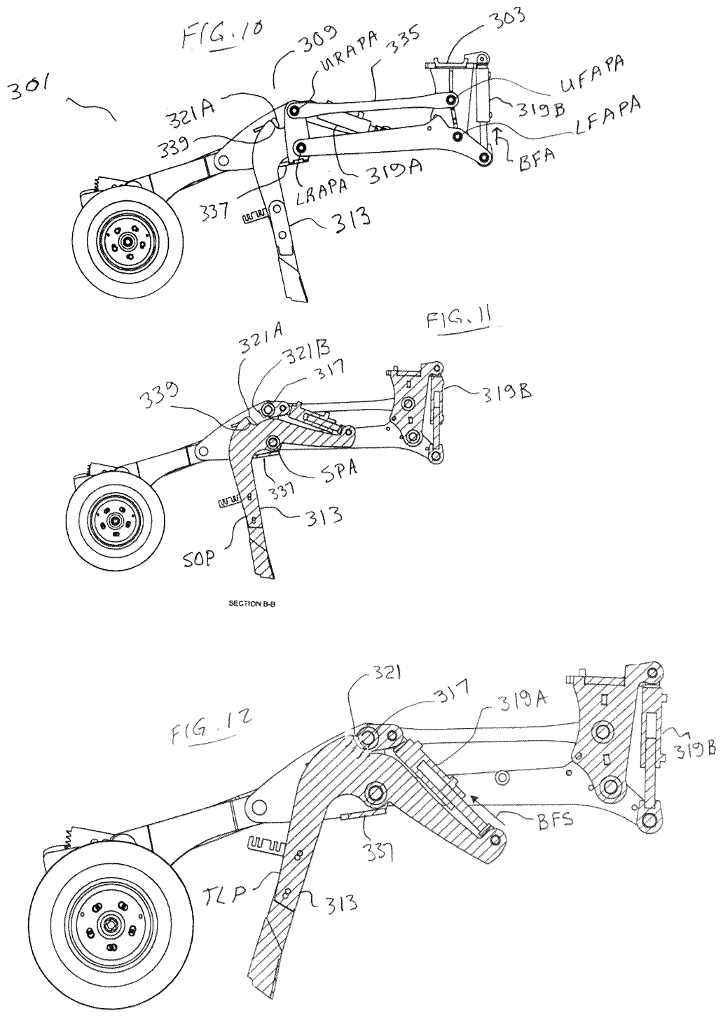

FIGS. 1-3 schematically illustrate a side view of a fairly simple seeding apparatus 1 comprising an implement frame 3 mounted on wheels 5 for travel over the ground 7 in an operating travel direction T. In FIGS. 1-3 the seeding apparatus I comprises a trailing arm apparatus 9 that is a single member, while in the seeding apparatus 301 of FIGS. 10-12 the trailing arm apparatus 209 includes a parallel arm assembly, as well as separate bias elements for each of the shank and the trailing arm apparatus.

A trailing arm apparatus 9 is pivotally attached at a front portion thereof to the implement frame 3 and extends rearward and downward to a packer wheel rotatably mounted to a rear portion of the trailing arm. The trailing arm apparatus 9 is biased downward and the packer wheel 11 rolls along the ground 7 and in undulating terrain moves upward and downward against the downward bias force BF with respect to the implement frame 3.

A shank 13 is pivotally attached at an upper portion thereof to the trailing arm apparatus 9 about a substantially horizontal shank pivot axis SPA, and a furrow opener 15 is attached to a lower end of the shank 13. Further farrow openers can be attached to the trailing arm apparatus 9 as desired.

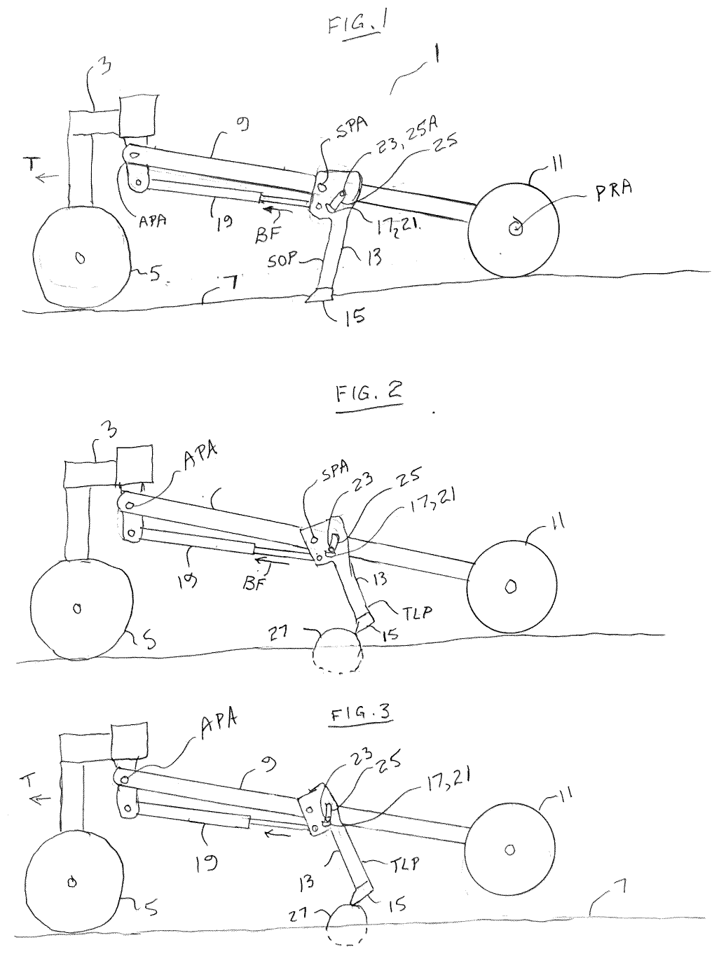

The shank 13 is operative to pivot forward and rearward about the shank pivot axis SPA in a trip range between a forward shank operating position SOP and a rearward stop member 17 at a trip limit position TLP shown in FIG. 2.

A shank bias element, pictured as a hydraulic cylinder 19, is attached to the implement frame 3 and to the shank 13 and is operative to exert the bias force BF on the shank 13 toward the shank operating position SOP, and also to exert the downward bias force on trailing arm apparatus 9. Varying the pressure in the hydraulic cylinder 19 varies the bias force BF.

A shock absorber 21 is operative to compress when the shank 13 pivots to a rear end of the trip range against the rearward stop member 17 in the trip limit position TLP.

FIG. 1 illustrates the seeding apparatus 1 in a normal working position with the shank 13 in the shank operating position SOP with the hydraulic cylinder 19 pulling the shank forward against a limit pin 23 fixed to the trailing arm 9. The hydraulic cylinder 19 thus exerts the bias force BF on the shank 13 and on the trailing arm apparatus 9.

In the seeding apparatus 1 an upper end of the shank 13 defines the shank pivot axis SPA and a limit slot 25, and the limit pin 23 is fixed to the trailing arm apparatus 9 and extends into the limit slot 25. As the shank 13 pivots in the trip range the limit pin 23 moves in the limit slot 25 from the first end 25A of the limit stop, where the shank 13 is in the shank operating position SOP, to the second end of the limit slot 25 at the rearward stop member 17. During operation, the hydraulic cylinder 19 continues to exert the bias force BF on the shank 13.

FIG. 2 schematically illustrates the furrow opener 15 striking a large rock 27 in the ground 7 such the shank 15 is forced rearward and upward against the bias force BF until it reaches the trip limit position TLP. As the limit pin 23 approaches the second end of the limit slot 25 at the rearward stop member 17 it contacts the shock absorber 21. The shock absorber 21 compresses and this compression exerts a force against the limit pin 23 that slows the limit pin 23 as it moves toward the rearward stop member 17. Slowing the limit pin 23 as it reaches the end of the trip range reduces the force of the impact and so also reduces failures of the apparatus 1.

FIG. 3 schematically illustrates the apparatus I with the hydraulic cylinder 19 further extended and the trailing arm apparatus 9 raised further such that the packer wheel 11 is lifted above the ground 7. When the seeding apparatus I passes over the rock 27. the shank 13 returns to the shank operating position SOP and the packer wheel 11 again presses against the ground 7.

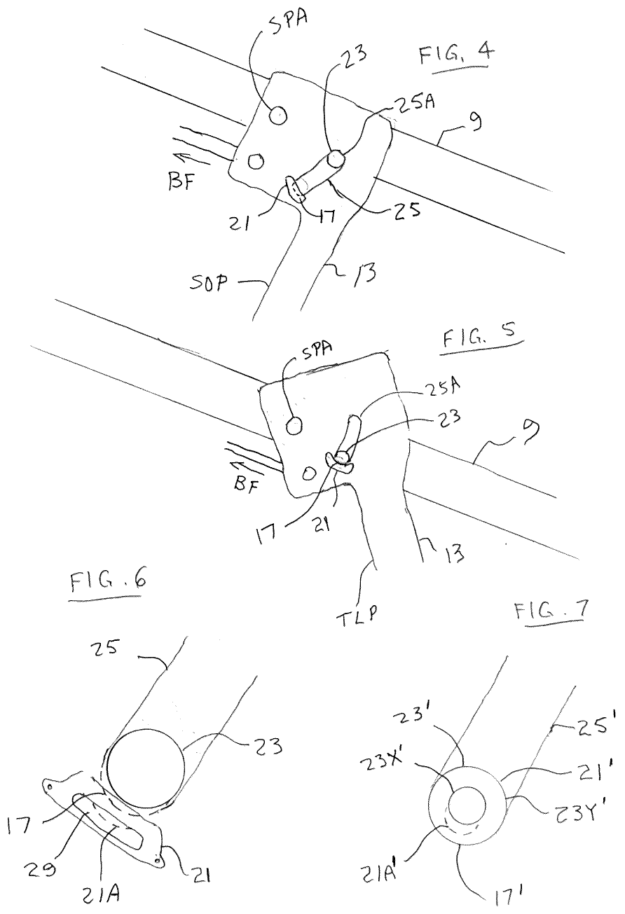

FIG. 4 schematically illustrates the bias force BF holding the shank 13 in the shank operating position SOP and the limit pin 23 at the first end 25A of the limit slot 25 and the rearward stop member 17 at the second end of the limit slot 25. The shock absorber 21 is located so that as the limit pin 23 approaches the second end of the limit slot 25 as shown in FIG. 6, the limit pin 23 strikes the shock absorber 21 which slows the limit pin 23 before it reaches the rearward stop member 17. FIG. 5 shows the shock absorber 21 collapsed and the limit pin 23 against the rearward stop member 17 in the trip limit position TLP.

FIG. 6 illustrates the shock absorber 21 as a resilient bumper that defines an empty space 29 in an interior thereof. FIG. 6 shows the collapsed position 21A of the shock absorber 21 in dotted lines.

FIG. 7 schematically illustrates an alternate shock absorber 21′ connected to the limit pin 23′. The illustrated limit pin 23′ comprises a solid inner core 23X′ and a resilient outer covering 23Y′. As the limit pin 23′ approaches the rearward stop member 17′, the outer covering 23Y′collapses to the collapsed position 21A′.

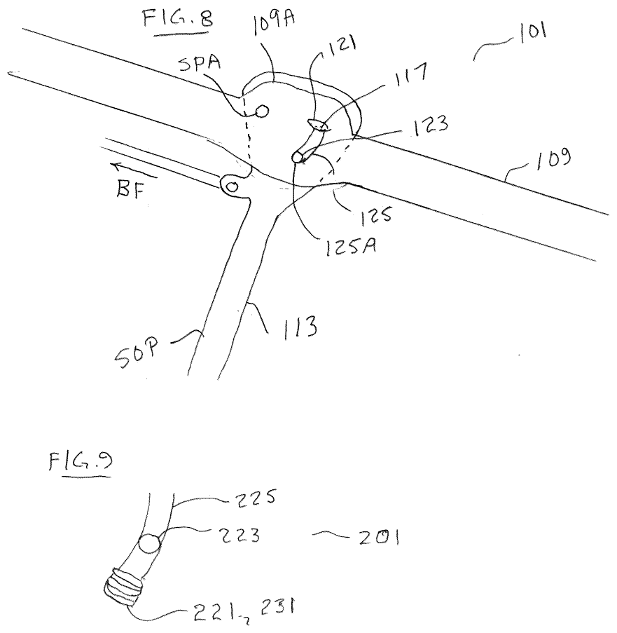

FIGS. 1-6 show the shock absorber 21 located on the shank 13. Alternatively as schematically illustrated in the apparatus 101 of FIG. 8, the limit slot 125 can be defined on the trailing arm apparatus 109 and the limit pin 123 can be fixed to the shank 113, with the shank 113 pivoting about the shank pivot axis SPA. The limit pin 123 extends into the limit slot 125, and when the shank 113 is in the shank operating position SOP the limit pin bears against a first end 125A of the limit slot 125, and the rearward stop member 117 is provided by the opposite second end of the limit slot 125.

In the illustrated apparatus 101, the first end of the first end 125A of the limit slot 125 is at the bottom of the limit slot 125 and the second end and rearward stop member 117 are at the top end of the limit slot 125. In the illustrated seeding apparatus 101 the limit slot 125 is shown extending through the trailing arm 109 and so the trailing arm 109 is strengthened by adding wider portions 109A.

It is further contemplated that the limit pin 123 could simply extend into the limit slot 125 instead of passing through the limit slot 125.

FIG. 9 schematically illustrates a further alternative seeding apparatus 201 where the shock absorber 221 is provided by a compression spring 231 at the second end of the limit slot 225.

FIGS. 10-12 illustrate a further alternative seeding apparatus 301 wherein the front portion of the trailing arm apparatus 309 comprises a parallel arm assembly 335 pivotally attached to the implement frame 303 about upper and lower front arm pivot axis UFAPA LFAPA. FIGS. 11 and 12 are cut away to show the operation of the seeding apparatus 301.

The shank 313 extends downward from the trailing arm apparatus 309 rearward of the parallel arm assembly 335. In contrast to the seeding apparatus 1 of FIGS. 1-3 the seeding apparatus 301 provides one hydraulic cylinder 319A to provide the shank bias element and the hydraulic cylinder 319A is connected to the trailing arm apparatus 309, and another hydraulic cylinder 319B to provide an arm bias element that is connected to the implement frame 303 and exerts the downward bias force BFA on the trailing arm apparatus 309.

The shank pivot axis SPA is provided by the lower rear arm pivot axis LRAPA and the rearward stop member 317 is provided by the upper rear arm pivot axis URAPA, such that the trip range is between a forward stop member 337, where the shank 313 is in the shank operating position SOP, and the upper rear arm pivot axis URAPA. The shock absorber 321 can be provided on the notch 339 of the shank 313 as shown by shock absorber 321A, or on the rearward stop member 317 as shown by shock absorber 321B.

FIGS. 10 and 11 show the shank in the shank operating position SOP and FIG. 12 shows the shank 313 in the trip limit position TLP.

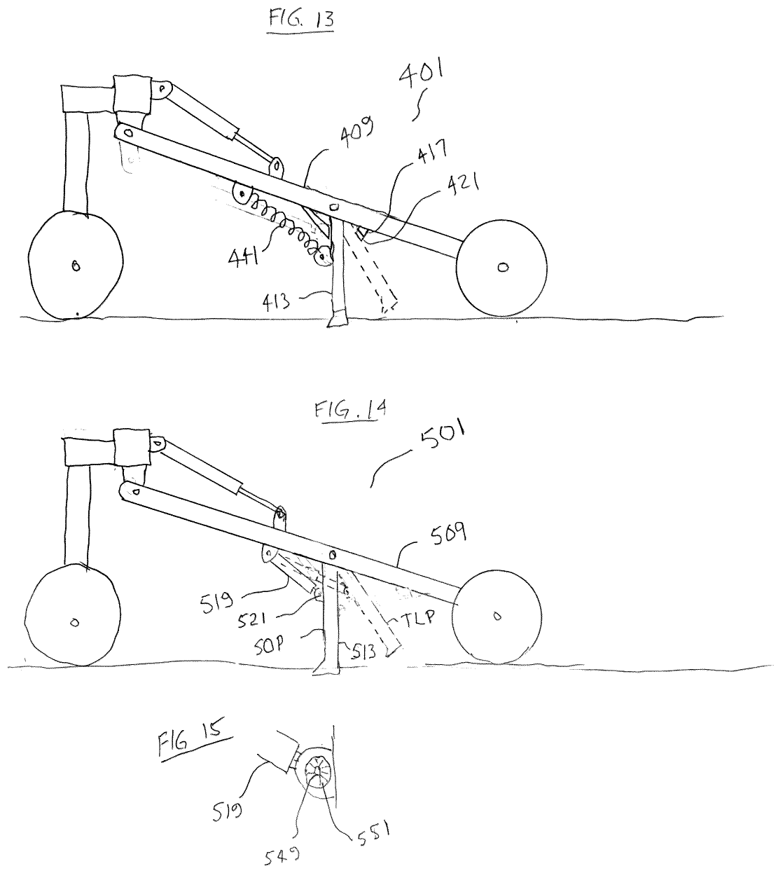

FIG. 13 schematically illustrates a further alternative seeding apparatus 401 where the shank 413 is pivotally connected to the trailing arm apparatus 409. Here the shank bias element is provided by a spring 441 and the trip range is defined by a front stop 437, where the shank 413 is in the shank operating position SOP and rear stop 417. The shock absorber 421 is provided by a resilient bumper on the rear stop.

FIG. 14 schematically illustrates a further alternative seeding apparatus 501 where the shank 513 is pivotally connected to the trailing arm apparatus 509. Here the shank bias element is provided by a shank hydraulic cylinder 519, and the shank hydraulic cylinder is configured such that the hydraulic cylinder 519 is fully collapsed when the shank 513 is in the shank operating position SOP, and fully extended when the shank is in the trip limit position TLP. The shock absorber 521 is shown in FIG. 15 and comprises a solid pin 549 with a deep resilient cover 551.

The apparatus of the present invention reduces damage to trailing arm type furrow openers by reducing the speed at which the shank contacts the end of the trip range, and thus reducing shock forces on the seeding apparatus.

The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

1. A seeding apparatus comprising:
an implement frame mounted on wheels for travel over the ground in an operating travel direction;
a trailing arm apparatus pivotally attached at a front portion thereof to the implement frame and extending rearward and downward to a packer wheel rotatably mounted to a rear portion of the trailing arm wherein the trailing arm apparatus is biased downward and the packer wheel moves upward and downward against a downward bias force with respect to the implement frame;
a shank pivotally attached at an upper portion of the shank to the trailing arm apparatus about a substantially horizontal shank pivot axis, and a furrow opener attached to a lower end of the shank;
wherein the shank is operative to pivot forward and rearward about the shank pivot axis in a trip range between a forward shank operating position and a rearward stop member;
a shank bias element attached to the shank and operative to exert a shank bias force on the shank toward the shank operating position; and
a shock absorber operative to compress when the shank pivots to a rear end of the trip range.

2. The apparatus of claim 1 wherein the shank bias element is connected to one of the implement frame and the trailing arm apparatus.

3. The apparatus of claim 1 wherein the shock absorber is located on one of the trailing arm apparatus and the shank.

4. The apparatus of claim 1 wherein the shock absorber is provided by a spring.

5. The apparatus claim 1 wherein the shock absorber is provided by a resilient bumper.

6. The apparatus of claim 5 wherein the resilient bumper defines an empty space in an interior thereof.

7. The apparatus of claim 1 wherein:
one of the trailing arm apparatus and the shank defines a limit slot;
a limit pin is fixed to the other of the trailing arm apparatus and the shank;
the limit pin extends into the limit slot, and wherein when the shank is in the shank operating position the limit pin bears against a first end of the limit slot, and wherein the rearward stop member is provided by an opposite second end of the limit slot.

8. The apparatus of claim 7 wherein the shock absorber is attached at the second end of the limit slot.

9. The apparatus of claim 7 wherein the shock absorber is connected to the limit pin.

10. The apparatus of claim 9 wherein the limit pin comprises a solid inner core and a resilient outer covering.

11. The apparatus of claim 1 wherein the front portion of the trailing arm apparatus comprises a parallel arm assembly, wherein the shank extends downward from the trailing arm apparatus rearward of the parallel arm assembly.

12. The apparatus of claim 11 wherein the shank bias element is connected to the trailing arm apparatus, and wherein an arm bias element exerts the downward bias force on the trailing arm apparatus.

13. The apparatus of claim 12 wherein the shank pivot axis is provided by a lower rear arm pivot axis and the rearward stop member is provided by an upper rear arm pivot axis.

14. The apparatus of claim 13 wherein the trip range is between a forward stop member, where the shank is in the shank operating position, and the upper rear arm pivot axis.
